(19) United States
(12) Patent Application Publication
(10) Pub. No.: US 2014/0208342 A1
(43) Pub. Date: Jul. 24, 2014

(54) Intelligent Interactive TV Remote-Control System

(71) Applicant: TATUNG TECHNOLOGY INC., Taipei (TW)

(72) Inventors: Ming Yu CHOU, Taipei (TW); Shih-Ting TANG, Taipei (TW)

(73) Assignee: Tatung Technology Inc., Taipei (TW)

(21) Appl. No.: 13/870,024

(22) Filed: Apr. 25, 2013

(30) Foreign Application Priority Data
Jan. 24, 2013 (TW) 102102625

(51) Int. Cl. H04N 21/422

(52) U.S. Cl. CPC H04N 21/42204
USPC 725/25

(57) ABSTRACT

An intelligent interactive TV remote-control system includes: a server, a TV device, a set-top box device, and an intelligent interactive remote-control device. The server is used for storing multimedia data and providing usage authentication service. The TV device is provided for playing multimedia data. The set-top box device is connected to the server and the TV device for downloading multimedia data from the server and outputting the same to the TV device for display. The intelligent interactive remote-control device is started for being connected to the server to perform usage authentication service thereby matching with the set-top-box device. When matching is successful, the intelligent interactive remote-control device is connected to the set-top box device and an interactive remote-control interface is generated corresponding to a playing window outputted from the set-top box device and displayed on the TV device for remotely controlling the set-top box device.

### BACKGROUND OF THE INVENTION

1.Field of the Invention

The present invention relates to a TV remote-control system and, more particularly, to an intelligent interactive TV remote-control system capable of generating an interactive remote-control interface according to a multimedia data outputted from a set-top box device to be displayed on a TV.

2. Description of Related Art

In recent years, with the widespread use of a digital TV set-top box, the remote control corresponding to it is also provided with more and more various functional combinations. However, in order to satisfy all functions of the remote control, the functional keys of the remote control become too many and extremely complicated. When simply using a remote control to correspond to one remotely controlled device, only a few keys of the remote control are used and the other keys are redundant and useless.

Although there is a known remote control having changeable operation interface available in the market, the operation interface of the remote control cannot be automatically changed by itself according to the usage situation or the function that user needs, and thus it generally needs to manually switch the operation interface of the remote control. For example, a user needs to push down a certain functional button for switching to a desired operation interface. In other words, when the user wants to enter a sound-control searching mode by using the remote control to control the set-top box, a certain sound-control functional button must be pressed by the user to allow the operation interface of the remote control to enter the sound-control searching mode.

Therefore, it is desirable to provide an improved intelligent interactive TV remote-control system so that the user does not need to press certain functional buttons to switch to certain operation interfaces that user needs.

### SUMMARY OF THE INVENTION

The object of the present invention is to provide an intelligent interactive TV remote-control system that obviate one or more of the problems due to limitations and disadvantages of the related art.

To achieve the object, there is provided an intelligent interactive TV remote-control system, which comprises: a server for storing multimedia data and providing usage authentication service; a TV device for playing multimedia data; a set-top box device connected to the server and the TV device for downloading multimedia data from the server and outputting the same to the TV device for display; and an intelligent interactive remote-control device for being started and connected to the server to perform the usage authentication service thereby matching with the set-top box device, wherein, when matching is successful, the intelligent interactive remote-control device is connected to the set-top box device and at least one interactive remote-control interface is generated corresponding to at least one playing window outputted from the set-top box device and displayed on the TV device for remotely controlling the set-top box device. Accordingly, in the intelligent interactive TV remote-control system of the present invention, the intelligent interactive remote-control device is started and connected to the server to perform usage authentication service thereby matching with the set-top box device. When the matching is successful, the intelligent interactive remote-control device is connected to the set-top box device and, at this moment, at least one interactive remote-control interface is generated corresponding to at least one playing window outputted from the set-top box device to the TV for remotely controlling the set-top box device. That is, after the intelligent interactive remote-control device is connected to the set-top box device, when at least one playing window outputted from the set-top box device to the TV can perform a certain function, the intelligent interactive remote-control device automatically generates the at least one interactive remote-control interface corresponding to the at least one playing window, and the functional button on the at least one interactive remote-control interface can perform a certain function on the at least one playing window.

In the intelligent interactive TV remote-control system, when the at least one playing window is a multimedia data choosing window, the at least one interactive remote-control interface is a multimedia data choosing interface.

In the intelligent interactive TV remote-control system, when the at least one playing window is a sound-control window, the at least one interactive remote-control interface is a microphone interface.

In the intelligent interactive TV remote-control system, when the at least one playing window is a text input window, the at least one interactive remote-control interface is a text keyboard interface.

In the intelligent interactive TV remote-control system, when the at least one playing windows is a keying number window, the at least one interactive remote-control interface is a number keyboard interface.

In the intelligent interactive TV remote-control system, when the at least one playing window is a video playing window, the at least one interactive remote-control interface is a video playing interface.

In the intelligent interactive TV remote-control system, when the at least one playing window is a TV playing window, the at least one interactive remote-control interface is a TV playing interface.

The multimedia data can be pay movies, TV program, video, or any kinds of multimedia data for playing.

The intelligent interactive remote-control device is connected to the server via a communication network for entering usage authentication service thereby matching with the set-top box device.

The communication network can be Long-Term Evolution (LTE), Worldwide Interoperability for Microwave Access (WiMAX), High Speed Downlink Packet Access (3.5-rd Generation, HSDPA, 3.5G), Universal Mobile Telecommunications System (3-rd Generation, UMTS, 3G), and Wireless Fidelity (Wi-Fi).

The intelligent interactive remote-control device is connected to the set-top box via a local area network for performing interactive remote-controlling.

The local area network can be Wi-Fi, Infrared (IR), Bluetooth, and radio frequency.

The intelligent interactive remote-control device can be smart phone, smart tablet, or PDA.

The set-top box device is further connected to a multimedia player for playing video files.

Other objects, advantages, and novel features of the invention will become more apparent from the following detailed description when taken in conjunction with the accompanying drawings.

### BRIEF DESCRIPTION OF THE DRAWINGS

FIG. 1 is a schematic diagram of an intelligent interactive TV remote-control system in accordance with the present invention;

FIG. 2 is a schematic diagram of the playing window being a multimedia data choosing window;

FIG. 3 is a schematic diagram of the playing window being a pay movie choosing window;

FIG. 4 is a schematic diagram of the playing window being a numeral input window;

FIG. 5 is a schematic diagram of the interactive remote-control interface being a multimedia data choosing interface;

FIG. 6 is a schematic diagram of the interactive remote-control interface being a microphone interface;

FIG. 7 is a schematic diagram of the interactive remote-control interface being a text keyboard interface;

FIG. 8 is a schematic diagram of the interactive remote-control interface being a numeral keyboard interface;

FIG. 9 is a schematic diagram of the interactive remote-control interface being a video playing interface; and

FIG. 10 is a schematic diagram of the interactive remote-control interface being a TV playing interface.

### DETAILED DESCRIPTION OF THE PREFERRED EMBODIMENT

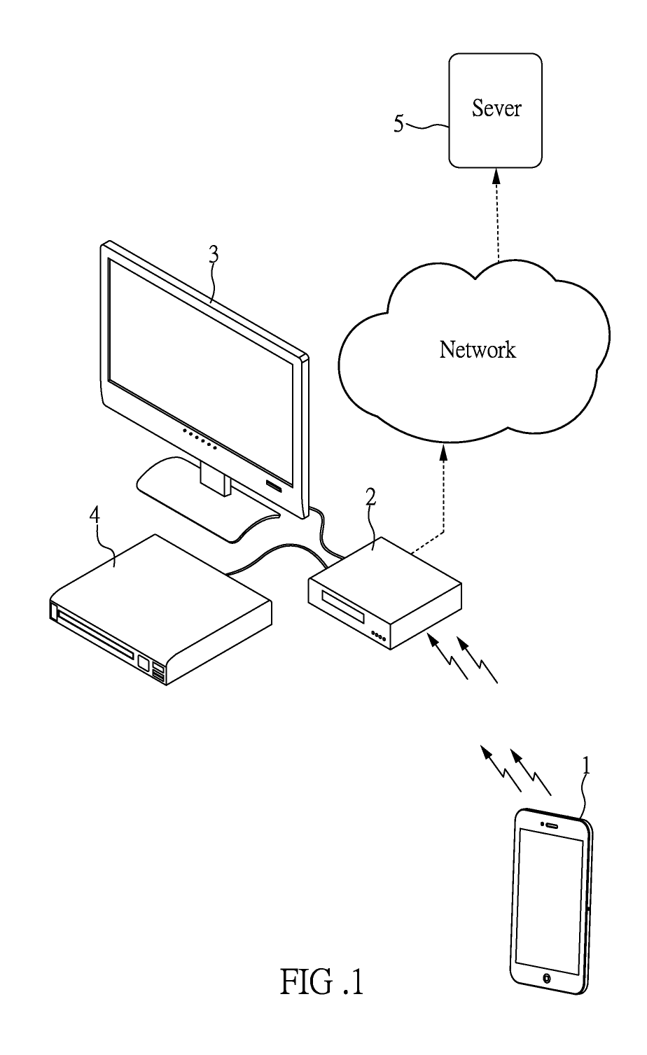

FIG. 1 schematically illustrates an intelligent interactive TV remote-control system in accordance with the present invention, which includes: a server 5, a TV device 3, a set-top box device 2, and an intelligent interactive remote-control device 1.

The server 5 is used to store multimedia data and provide usage authentication service. The TV device 3 is used to play multimedia data. The set-top box device 2 is connected to the server 5 via a network and the TV 3 for downloading multimedia data from the server 5 and outputting the same to the TV device 3 for display. The intelligent interactive remote-control device 1 can be a smart phone, a smart tablet, or a PDA, which is connected, after being started, to the server 5 for performing the usage authentication service so as to match with the set-top box device 2. When the matching is successful, the intelligent interactive remote-control device 1 is connected to the set-top box device 2 and an interactive remote-control interface is generated corresponding to a playing window outputted from the set-top box device 2 and displayed on the TV device 3 so as to remotely control the set-top box device 2.

Thus, after the intelligent interactive remote-control device 1 is connected to the set-top box device 2, when at least one playing window outputted from the set-top box device 2 and displayed on the TV device 3 can execute a certain function, the intelligent interactive remote-control device 1 automatically generates at least one interactive remote-control interface corresponding to the at least one playing window and the functional keys on the at least one interactive remote-control interface can execute a certain function on the playing window.

With reference to FIGS. 2 and 5, there are respectively shown the playing window being a multimedia data choosing window and the interactive remote-control interface being a multimedia data choosing interface. In this embodiment, when the intelligent interactive remote-control device 1 is started, it connects to the server 5 by using a communication network, such as LTE, WiMAX, 3.5G, 3G, and Wi-Fi, for performing the usage authentication service so as to match with the set-top box device 2. When the intelligent interactive remote-control device 1 and the set-top box device 2 are matched successful, the intelligent interactive remote-control device 1 connects to the set-top box device 2 by using a local area network, such as Wi-Fi, IR, Bluetooth, and radio frequency, for performing interactive remote controlling operation. The playing window 305 outputted from the set-top box device 2 and displayed on the TV device 3 is for choosing multimedia data, which includes pay movies, TV programs, and videos, as shown in FIG. 2. Then, the intelligent interactive remote-control device 1 automatically generates an interactive remote-control interface, which is a multimedia data choosing interface 105 including functional keys such as up, down, left, right, and OK keys, as shown in FIG. 5, for allowing the user to choose the multimedia data that the user wants to watch. Typically, the user uses the up, down, left, and right keys to move a target area 301 to the multimedia data that the user wants to watch, and then presses the OK key to enter the next playing window.

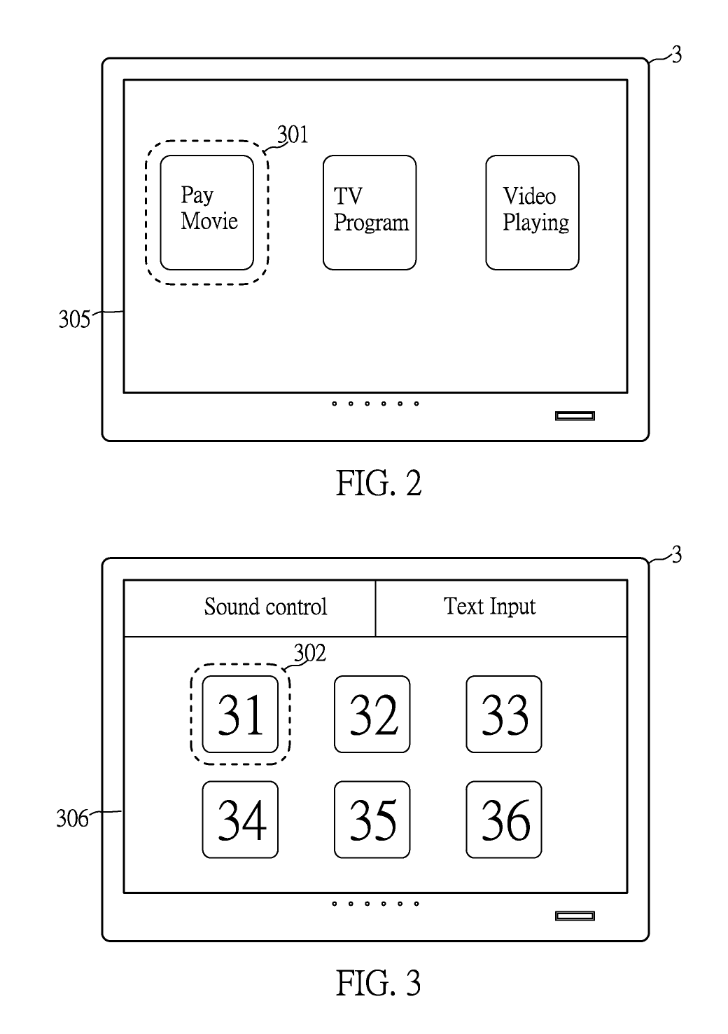

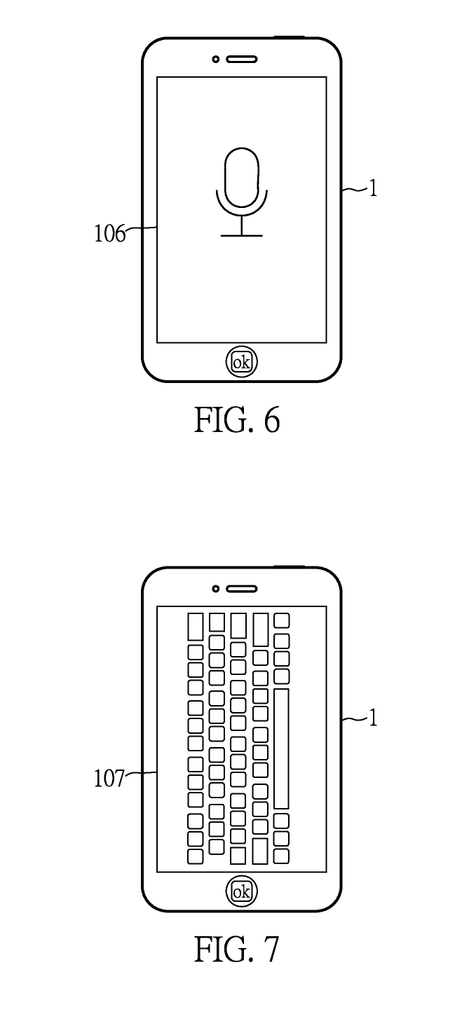

With reference to FIGS. 3, 5, 6 and 7, there are respectively shown the playing window being a pay movie choosing window, the interactive remote-control interface being a multimedia data choosing interface, the interactive remote-control interface being a microphone interface, and the interactive remote-control interface being a text keyboard interface. In this embodiment, after the user uses the intelligent interactive remote-control device 1 to move the target area 301 for choosing a pay movie option, a playing window 306 for choosing a certain pay movie and for searching a certain pay movie is displayed on the TV device 3, as shown in FIG. 3. When desiring to choose a certain pay movie slowly, the user uses the multimedia data choosing interface 105, as shown in FIG. 5, to move the target area 302 for choosing the pay movie that the user wants to watch. When desiring to use the sound-control searching function, the user can use the multimedia data choosing interface 105, as shown in FIG. 5, to move the target area 302 to the sound-control area. As a result, the intelligent interactive remote-control device 1 will automatically change the multimedia data choosing interface 105, as shown in FIG. 5, into the microphone interface 106, as shown in FIG. 6. At this moment, the user can search the pay movie that the user wants to watch by inputting sound. When desiring to use the text searching function, the user can use the multimedia data choosing interface 105, as shown in FIG. 5, to move the target area 302 to a text input area. Thus, the intelligent interactive remote-control device 1 will automatically change the multimedia data choosing interface 105, as shown in FIG. 5, into the text keyboard interface 107, as shown in FIG. 7. At this moment, the user can search the pay movie that the user wants to watch by keying text. When the pay movie that the user wants to watch is found, the user presses the OK key to enter the next playing window.

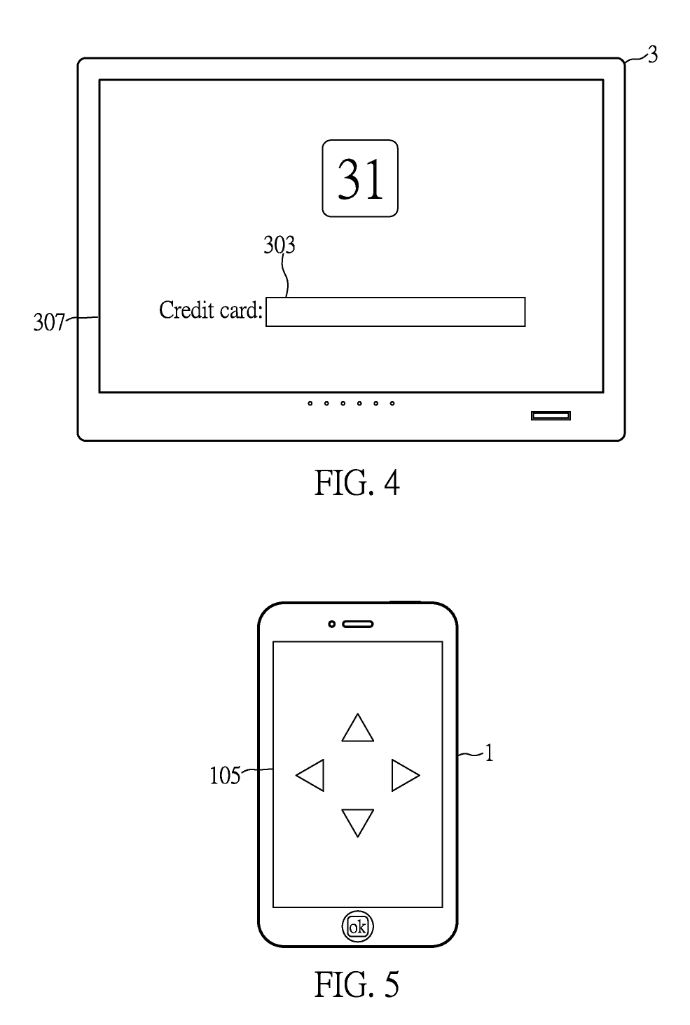

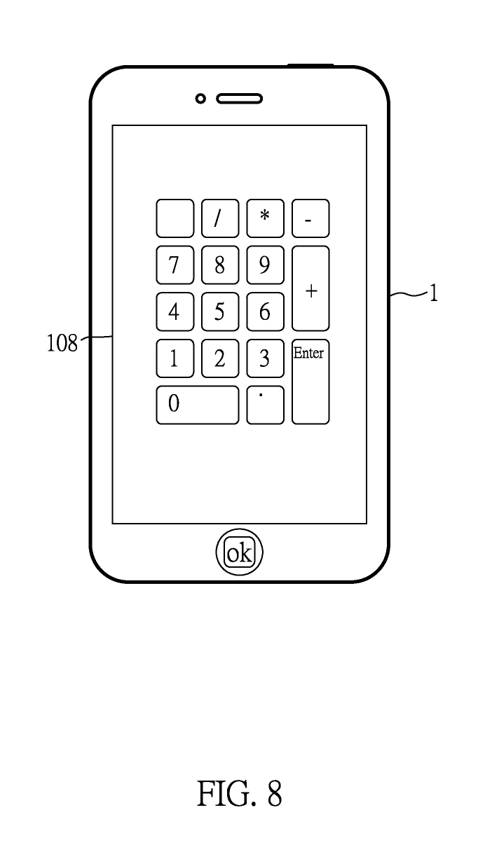

With reference to FIGS. 4 and 8, there are respectively shown the playing window being a numeral keying window, and the interactive remote-control interface being a numeral keyboard interface. In this embodiment, after the user uses the intelligent interactive remote-control device 1 to choose the pay movie that the user wants to watch, a playing window 307 for receiving numeral input of credit card number is displayed on the TV device 3, as shown in FIG. 4. At this moment, the intelligent interactive remote-control device 1 will automatically change into the numeral keyboard interface 108, as shown in FIG. 8, from other interfaces, so as to allow the user to enter credit card number in a window 303 by using the numeral keyboard for proceeding with online payment. As the online payment is completed, the user can play the chosen pay movie.

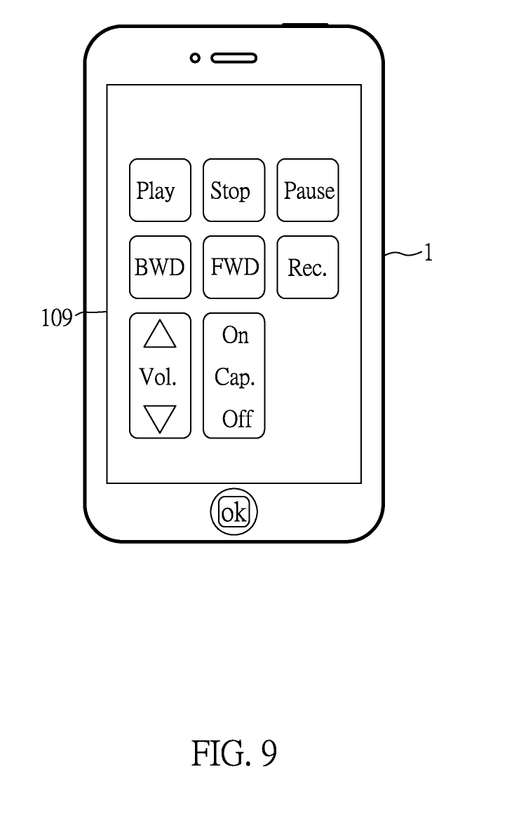

With reference to FIG. 9, there is shown the interactive remote-control interface being a video playing interface. In this embodiment, after the user chooses the pay movie and completes online payment, the pay movie is started to play and the intelligent interactive remote-control device 1 will automatically change the numeral keyboard interface 108 into the video playing interface 109 as shown in FIG. 9 for allowing the user to perform functions, such as play, stop, pause, forward, backward, voice adjustment, and captions display, onto the pay movie. In another embodiment, the set-top box device 2 can be connected to a multimedia player 4 for playing video files. When the user moves the target area 301 to the video playing option in the multimedia data choosing window as shown in FIG. 2, the intelligent interactive remote-control device 1 will automatically change the multimedia data choosing interface 105 into the video playing interface 109, as shown in FIG. 9, for allowing the user to perform functions on this video playing.

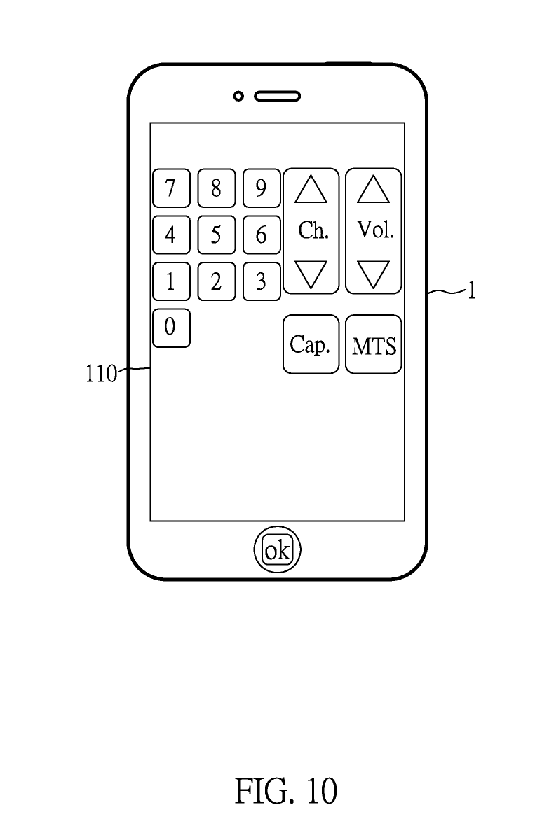

With reference to FIG. 10, there is shown the interactive remote-control interface being a TV remote-control interface. In this embodiment, when the user moves the target area 301 to the TV playing option in the multimedia data choosing window as shown in FIG. 2, the intelligent interactive remote-control device 1 will automatically change the multimedia data choosing interface 105 into the TV playing interface 110, as shown in FIG. 10, for allowing the user to perform functions, such as channel selection, voice adjustment, captions display, and multi-channel television sound selection.

Although the present invention has been explained in relation to its preferred embodiment, it is to be understood that many other possible modifications and variations can be made without departing from the spirit and scope of the invention as hereinafter claimed.

What is claimed is:

1. An intelligent interactive TV remote-control system, comprising:
a server for storing multimedia data and providing usage authentication service;
a TV device for playing multimedia data;
a set-top box device connected to the server and the TV device for downloading multimedia data from the server and outputting the same to the TV device for display; and
an intelligent interactive remote-control device for being started and connected to the server to perform the usage authentication service thereby matching with the set-top box device, wherein, when matching is successful, the intelligent interactive remote-control device is connected to the set-top box device and at least one interactive remote-control interface is generated corresponding to at least one playing window outputted from the set-top box device and displayed on the TV device for remotely controlling the set-top box device.

2. The system as claimed in claim 1, wherein, when the at least one playing window is a multimedia data choosing window, the at least one interactive remote-control interface is a multimedia data choosing interface.

3. The system as claimed in claim 1, wherein, when the at least one playing window is a sound-control window, the at least one interactive remote-control interface is a microphone interface.

4. The system as claimed in claim 1, wherein, when the at least one playing window is a text input window, the at least one interactive remote-control interface is a text keyboard interface.

5. The system as claimed in claim 1, wherein, when the at least one playing window is a numeral input window, the at least one interactive remote-control interface is a numeral keyboard interface.

6. The system as claimed in claim 1, wherein, when the at least one playing window is a video playing window, the at least one interactive remote-control interface is a video playing video interface.

7. The system as claimed in claim 1, wherein, when the at least one playing window is a TV playing window, the at least one interactive remote-control interface is a TV playing interface.

8. The system as claimed in claim 1, wherein the intelligent interactive remote-control device is connected to the server via a communication network for entering the usage authentication service thereby matching with the set-top box device.

9. The system as claimed in claim 8, wherein the communication network is one of LTE, WiMAX, 3.5G, 3G, and Wi-Fi.

10. The system as claimed in claim 1, wherein the intelligent interactive remote-control device is connected to the set-top box via a local area network for perform interactive remote-controlling.

11. The system as claimed in claim 10, wherein the local area network is one of Wi-Fi, IR, Bluetooth, and radio frequency.

12. The system as claimed in claim 1, wherein the intelligent interactive remote-control device is one of smart phone, smart tablet, and PDA.

13. The system as claimed in claim 1, wherein the set-top box device is further connected to a multimedia player for playing video files.
